(19) United States
(12) Patent Application Publication
(10) Pub. No.: US 2003/0057616 A1
(43) Pub. Date: Mar. 27, 2003

(54) End attachment component for air springs with larger or multiple ports

(76) Inventor: Joe Morrow, Mesa, AZ (US)

Correspondence Address: CHASSIS TECH / JOE MORROW, 260 S. HIBBERT ST., MESA, AZ, 85210, US

(21) Appl. No.: 09/961,806

(22) Filed: Sep. 25, 2001

(51) Int. Cl. F16F 9/43

(52) U.S. Cl. 267/64.28

(57) ABSTRACT

This invention pertains to the end attachment components used on all air springs in the automotive and light truck suspension market. Previously these end attachment components have been composed of one or two threaded bungs used for mounting the finished product to its application and a single ¼″ or ⅜″ NPT port used to pressurize and depressurize the air bellow. This invention incorporates the use of a single larger port in sizes including but not limited to ½″, ¾″, 1″ and 1½″ NPT. This invention also incorporates the use of multiple ports in sizes including but not limited to ⅜″, ½″, ¾″, and 1″ NPT. The use of larger or multiple ports allow the user to pressurize or depressurize the air spring more rapidly.

### 1. TECHNICAL FIELD

The invention relates to the automotive and light truck industries where air springs are used in suspension aftermarket. Specifically to that of manufacturing end attachment components from stamped steel, machined and or cast aluminum with larger or multiple ports. Therefore allowing for charged air or co2 to enter the bellow more rapidly and exit in the same manner in which it came in.

### 2. BACKGROUND OF PRIOR ART

Air springs or air bellows having a flexible member of elastomeric material have been proven for decades as load and height controllable springs in the automotive and light truck industries. These air bellows are sealed off at each end by crimping an end attachment component constructed from stamped steel onto the bead-sealing ring of the air bellow. Another form of sealing the air spring ends are by clamping a bead ring with an end attachment component that can be constructed from steel or aluminum onto the bead sealing ring of the air below.

These are two of the most common types of end attachments used on air springs. These two types of end attachments are very dependable and have been proven for years in the air bellow aftermarket industry. However, the air bellow aftermarket industry only offers air springs with a single port, which is relatively small in diameter. The norm for these ports has been ¼″ or ⅜″ NPT and can not offer the response that is obtained from single larger or multiple ports when they are pressurized or depressurized with a propellant source.

### SUMMARY OF INVENTION

The objective of this invention is to provided end attachment components for air bellows with one larger or multiple ports. These ports will allow the user to pressurize or depressurize the air spring in a rapid amount of time. By using the industry proven design and methods these end attachment components can be constructed from steel or aluminum and are to be mounted or attached to the air springs accordingly.

The end attachment components with a single port is to be modified in order to accommodate ½″ NPT or larger ports. The end attachment components with multiple ports will accommodate ⅜″ NPT and larger ports. These two styles of end attachment components are aimed towards the automotive and light truck industries, particularly that of aftermarket suspension. This will allow the user to pressurize and depressurize his air springs at a much faster rate than before.

### BRIEF DESCRIPTION OF DRAWINGS

FIG. 1 is a drawing of a crimp on end attachment component with multiple ports, in an un-crimped state.

FIG. 2 is a drawing of a clamping style end attachment component. This incorporates an end attachment component with multiple ports and a bead-sealing ring.

FIG. 3 is a drawing of a clamping style end attachment component. This incorporates a bead sealing ring and an end attachment component with a single large port.

FIG. 4 is a drawing of a crimp on end attachment component with a single large port, in an un-crimped state.

### DETAILED DESCRIPTION OF THE PREFERRED EMBODIMENTS

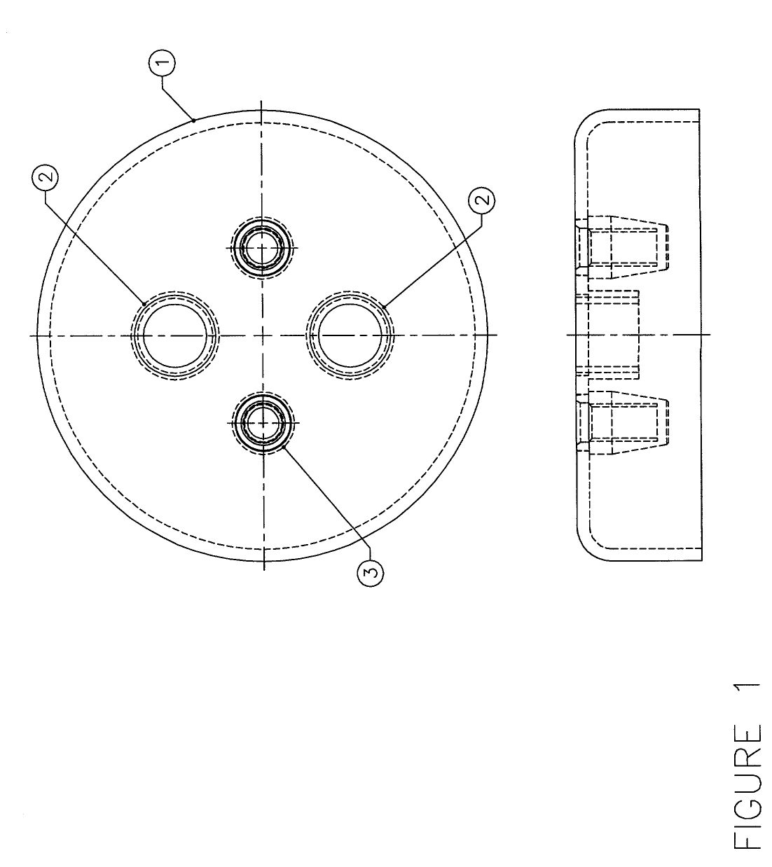

Referring to FIG. 1, an end attachment component (1) is shown prior to being crimped onto an air spring. This end attachment component (1) has multiple ports (2) brazed, welded or machined on two locations of the end attachment component (1). This end attachment component (1) also has two threaded bungs (3) brazed, welded or machined on two locations of the end attachment component (1) which are used for mounting the finished product onto its application. This type of end attachment component (1) is commonly manufactured from stamped steel and crimped onto the air bellow using a state of the art bag-crimping device.

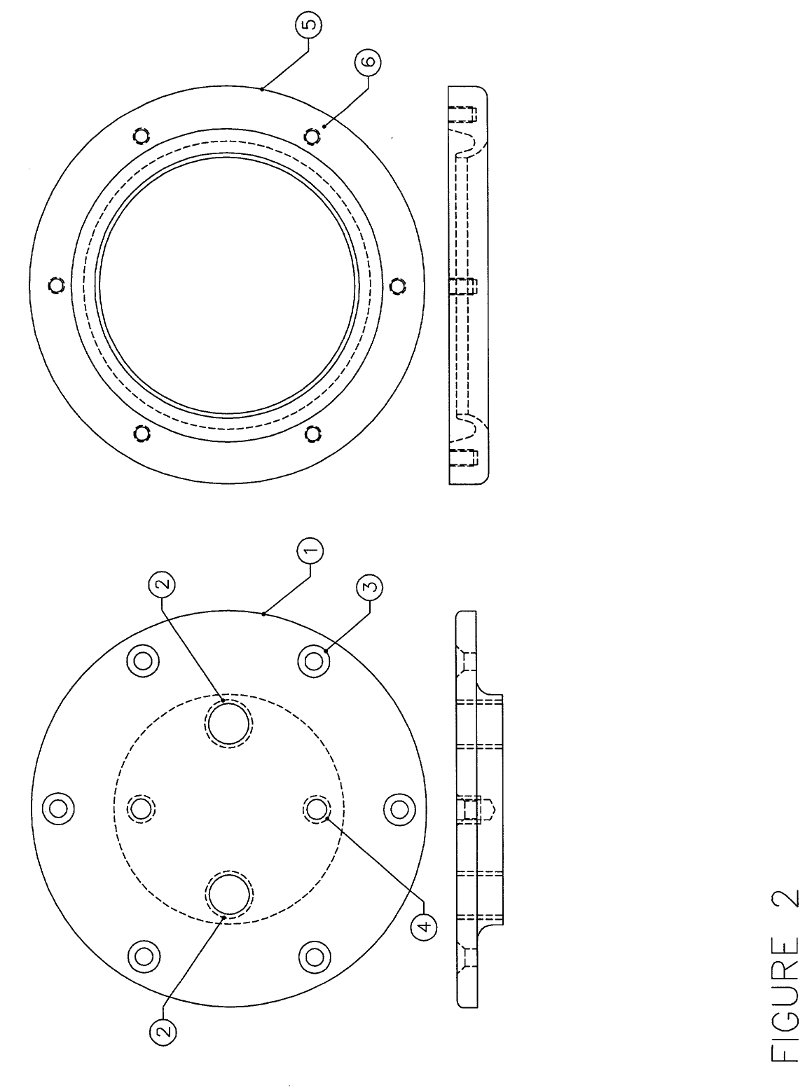

Referring to FIG. 2, an end attachment component (1) and a bead-sealing ring (5) are shown prior to being clamped onto an air spring. The end attachment component (1) has multiple ports (2) machined on two locations of the end attachment component (1). This end attachment component (1) also has two threaded holes (4) on two locations of the end attachment (1), which are used for mounting the finished product onto its application.

This style of end attachment component (1) also has several counter sunk holes (3) that are used for clamping an air bellow between end attachment component (1) and bead sealing ring (5) by tightening known screws thru counter sunken holes (3) onto threaded holes (6) on bead sealing ring (5). This type of end attachment component (1) and bead sealing ring (5) are commonly manufactured from steel or aluminum.

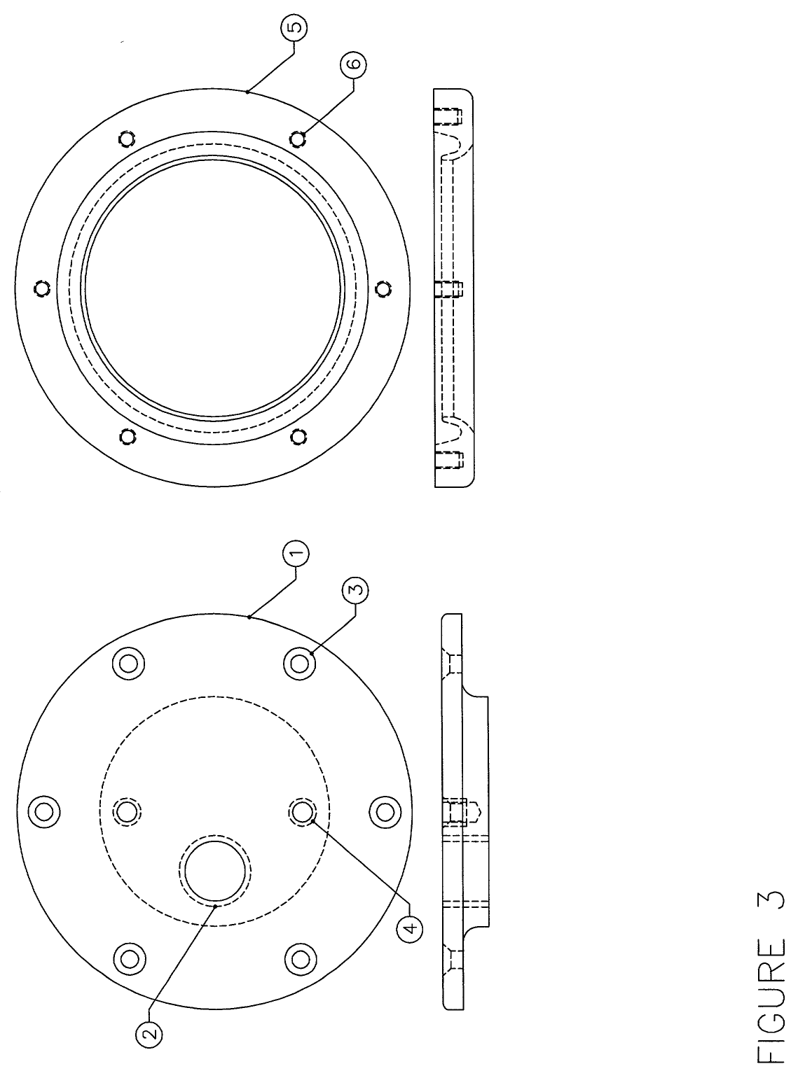

Referring to FIG. 3, an end attachment component (1) and a bead-sealing ring (5) are shown prior to being clamped onto an air spring. The end attachment component (1) has a single large port (2) machined on to the end attachment component (1). This end attachment component (1) also has two threaded holes (4) on two locations of the end attachment component (1), which are used for mounting the finished product onto its application.

This style of end attachment component (1) also has several counter sunk holes (3) that are used for clamping an air bellow between end attachment component (1) and bead sealing ring (5) by tightening known screws thru counter sunken holes (3) onto threaded holes (6) on bead sealing ring (5). This type of end attachment component (1) and bead sealing ring (5) are commonly manufactured from steel or aluminum.

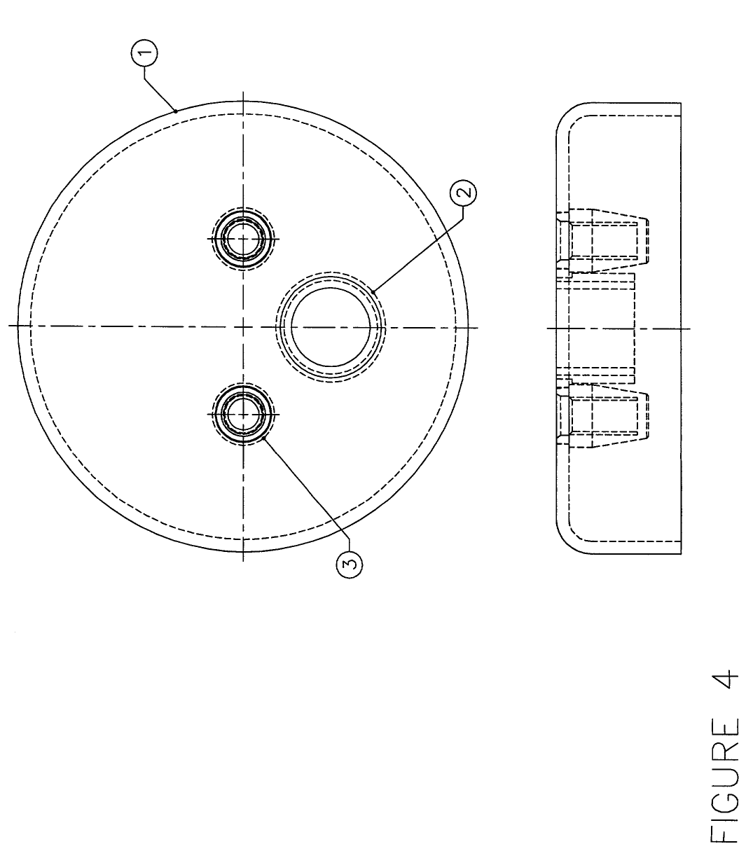

Referring to FIG. 4, an end attachment component (1) is shown prior to being crimped onto an air spring. This end attachment component (1) has a single large port (2) brazed, welded or machined on to the end attachment component (1). This end attachment component (1) also has two threaded bungs (3) brazed, welded or machined on two locations of the end attachment component (1) which are used for mounting the finish product onto its application. This type of end attachment component (1) is commonly manufactured from stamped steel and crimped onto the air bellow using a state of the art bag-crimping device.

What is claimed:

1. An end attachment component comprising:
A design where multiple ports in sizes including but not limited to ⅜″, ½″, ¾″ and 1″ NPT allow the user to pressurize and depressurize the air spring more rapidly.

2. An end attachment component comprising:
A design where a single larger port in sizes including but not limited to ½″, ¾″, 1″ and 1½″ NPT allow the user to pressurize or depressurize the air spring more rapidly.
